(19) United States
(12) Patent Application Publication
(10) Pub. No.: US 2002/0004094 A1
(43) Pub. Date: Jan. 10, 2002

(54) Process for coconut liquor

(76) Inventors: Rodolfo Minaya Rancier, Santo Domingo (DO); Mercedes Rancier Minaya, Santo Domingo (DO)

Correspondence Address: Sanchelima and Associates, P. A., Jesus Sanchelima, Esq., 235 S.W. Le Jeune Rd., Miami, FL, 33134, US

(21) Appl. No.: 09/897,285

(22) Filed: Jul. 2, 2001

(30) Foreign Application Priority Data
Jul. 3, 2000 (DO) 5611

(51) Int. Cl. C12G 1/00; A23L 1/212

(52) U.S. Cl. 426/592; 426/617

(57) ABSTRACT

A process for producing a liquor utilizing a coconut as the fermentation container and final container for distribution to consumers. The process includes the steps of filling pre-selected coconuts with ethanol, after emptying the water, to dissolve part of the cavity's internal walls thereby absorbing the fragrance of the coconut. The ethanol is allowed to stay inside the coconut for a predetermined amount of time and then added to a mixture of ethanol and sugar cane juice, fifty percent of each, in a predetermined proportion to enhance the aroma of the liquor. The resulting mixture is then placed inside the coconut's cavity where it is allowed to go through the process of fermentation for about 21 days. The coconut is then capped and stored for future consumption.

### BACKGROUND OF THE INVENTION

1. Field of the Invention

The present invention relates to a process for producing coconut liquor, and more particularly, to a process that includes using the natural coconut fruit as the container for the fermentation process.

2. Description of the Related Art

Many processes for producing liquor have been used in the past. None of them, however, include using the fruit as the container for the fermentation process of the liquor. During the fermentation of liquor produced in accordance with the present invention the mass inside the coconut, along with other ingredients, contributes in a special way to the final product imparting its unique fragrance.

### SUMMARY OF THE INVENTION

It is one of the main objects of the present invention to provide a process for producing a liquor wherein the coconut fruit is used as the container for the process during fermentation.

It is another object of this invention to provide a process for producing a liquor that utilizes the natural coconut fruit as the container for the final product.

It is yet another object of this invention to provide such a process that is inexpensive to implement.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of design and combination of elements as will be more fully understood from the following description, when read in conjunction with the accompanying drawings in which:

FIG. 1 shows the coconut fruit used as the container for the liquor.

FIG. 2 represents a diagram of the process.

### DETAILED DESCRIPTION OF THE PREFERRED EMBODIMENT

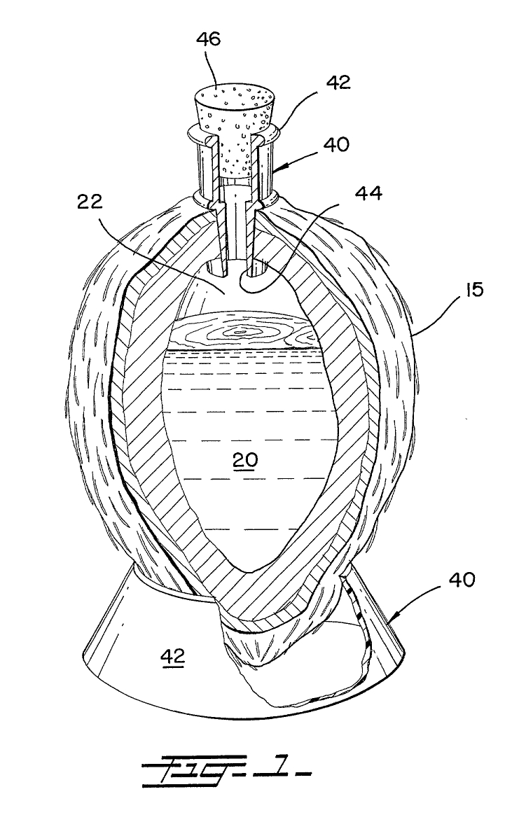

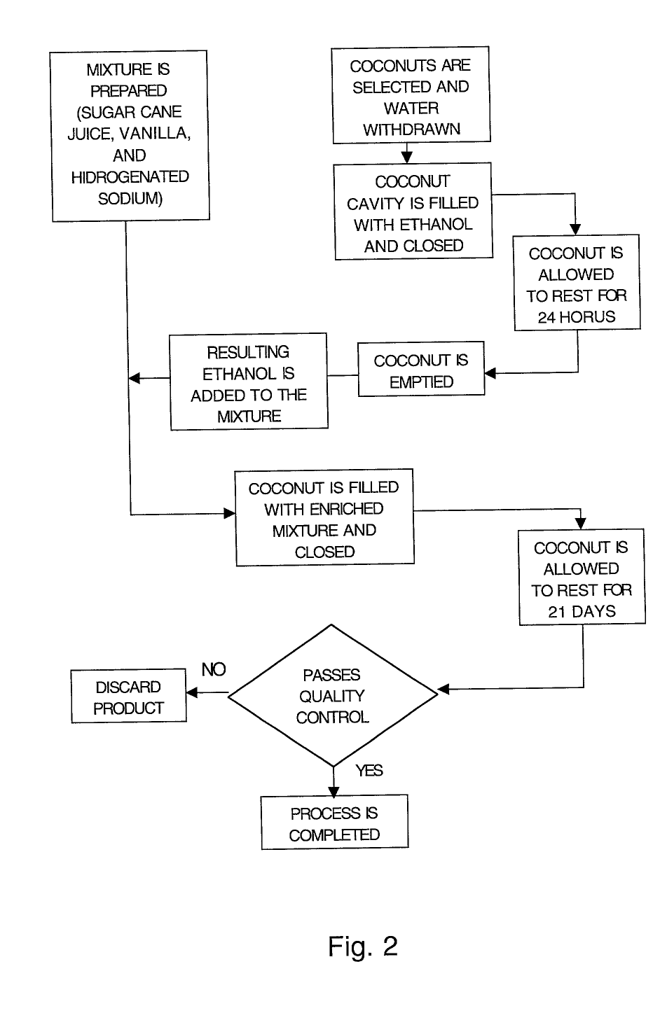

Referring now to the drawings, where the present invention basically includes the process steps referred to in FIG. 2, and results in a liquor product of unique qualities that carry the bouquet of the coconut. Additionally, the use of the coconut fruit C shown in FIG. 1, as the container during fermentation and for the final product ensures a natural dark environment that is stable for the product.

The first step involves the selection of the coconuts 15. This includes selection criteria based on the ripeness and dimension characteristics of the coconuts. Then, the selected coconuts 15 are peeled and punctured to create a hole 30 through its uppermost portion, and the coconut water is emptied for other uses.

Cylindrical member 40 is inserted through hole 30 keeping end 42 outside to receive cork member 46. The other end 44 protrudes inwardly inside cavity 22. Once the internal cavity 22 has been emptied, it is filled with alcohol (ethanol with concentration of 75%) and part of the outer layer of the coconut mass is dissolved. It has been found that approximately 7% of the alcohol is absorbed by the mass on the internal cavity of a coconut within 24 hours. This process is referred to as the “curing” of the coconut mass and reduces the absorption capabilities of the mass with time. In this manner, the permeability of the mass exposed to the alcohol is reduced. After 24 hours, the ethanol is discharged on a batch with a mixture 20 of ethanol and sugar cane juice. Part of the mass is also dissolved or brought in contact with the alcohol, such as oils, that carry the characteristic aroma and scent of the coconut. Applicant refers to this process as a “cyclic exchange”. It takes about 21 days for the coconut mass to release between 15 to 20% of its oils. During the next 7 to 8 months, the liquor reaches its maximum taste with approximately 80% of its characteristic oils being dissolved. The mixture 20 is brought to 50% of ethanol (of 75% concentration) and 50% sugar cane juice of 45-degree brix. Vanilla extract is added, preferably, 30 ml for each liter. Hydrogenated sodium is added to help in the preservation of the mixture 20. In the preferred embodiment 15 ml. of hydrogenated sodium per liter is added.

The mixture 20 is then placed inside the coconut cavity where it stays for 21 days. The fermentation process is generally concluded within a 16 days period after the enzymes reach the predetermined alcohol level. During that time the mixture 20 is kept away from the light. This ensures the stability of the product process. After 21 days, coconuts and mixture 20 are passed through a quality control program including sampling to ascertain the characteristics of the product.

To keep coconuts 15 in a stable vertical position, a frustroconical base 40 is used. Base assembly 40 adds to the aesthetics of the final product while providing display area 42 for commercial messages or decoration. Base assembly 40 doubles as an ashtray when coconut 15 is removed.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A process for producing a liquor, comprising the steps of:
A) selecting coconuts from a predetermined criteria for ripeness and dimensions;
B) creating a hole through the crown of said coconuts connecting the cavity of said coconuts to the exterior;
C) emptying the coconut water;
D) filling said cavity with ethanol;
E) allowing said ethanol to rest and coact with the internal walls of said cavity absorbing a predetermined amount of ethanol by the coconut mass defining said interval walls;
F) preparing a mixture consisting essentially of 50% of ethanol and 50% of sugar cane juice;
G) emptying cavity and adding the resulting ethanol to said mixture;
H) filling said coconut with the final mixture consisting of said mixture with the added resulting ethanol; and
I) allowing said final mixture to ferment over a second predetermined amount of time inside said coconut cavity.

2. The process set forth in claim 1 further including the step of:
J) capping said hole.

3. The process set forth in claim 2 wherein said mixture includes as much as 30 ml per liter of vanilla extract.

4. The process set forth in claim 3 wherein said mixture includes as much as 15 ml per liter of hydrogenated sodium.

5. The process set forth in claim 4 wherein said first predetermined amount of time is between 6 hours and 48 hours.
